(19) United States
(12) Patent Application Publication
(10) Pub. No.: US 2024/0290341 A1
(43) Pub. Date: Aug. 29, 2024

(54) OVER-SUPPRESSION MITIGATION FOR DEEP LEARNING BASED SPEECH ENHANCEMENT

(71) Applicant: Dolby Laboratories Licensing Corporation, San Francisco, CA (US)

(72) Inventors: Kai Li, Beijing (CN); Jia Dai, Beijing (CN); Xiaoyu Liu, Dublin, CA (US)

(73) Assignee: Dolby Laboratories Licensing Corporation, San Francisco, CA (US)

(21) Appl. No.: 18/571,963

(22) PCT Filed: Jun. 28, 2022
(86) PCT No.: PCT/US2022/035251

§ 371 Date: Dec. 19, 2023

Related U.S. Application Data
(60) Provisional application No. 63/225,594, filed on Jul. 26, 2021.
(60) Provisional application No. 63/288,516, filed on Dec. 10, 2021.

(30) Foreign Application Priority Data
Jul. 2, 2021 (WO) PCT/CN2021/104166

(51) Int. Cl. G10L 21/0232; G10L 21/0208; G10L 25/21; G10L 25/30

(52) U.S. Cl. CPC G10L 21/0232; G10L 25/21; G10L 25/30; G10L 2021/02082; G10L 2021/02087

(57) ABSTRACT

A system for mitigating over-suppression of speech and other non-noise signals is disclosed. In some embodiments, a system is programmed to train a first machine learning model for speech detection or enhancement using a non-linear, asymmetric loss function that penalizes speech over-suppression more than speech under-suppression. The first machine learning model is configured to receive an audio signal and generate a mask indicating an amount of speech present in the audio signal. The mask can be adjusted to remedy sharp voice decay resulting from speech over-suppression. The system is also programmed to train a second machine learning model for laughter or applause detection. The system is further programmed to improve the quality of a new audio signal by applying an adjusted mask to the new audio signal except for the portions of the audio signal that have been identified as corresponding to laughter or applause.

### CROSS-REFERENCE TO RELATED APPLICATIONS

This application claims the priority benefit of U.S. Provisional Application No. 63/225,594, filed Jul. 26, 2021, U.S. Provisional Application No. 63/288,516, filed Dec. 10, 2021, and International Application No. PCT/CN2021/104166, filed Jul. 2, 2021, each of which is hereby incorporated in their entirety.

### TECHNICAL FIELD

The present application relates to audio processing and machine learning.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In recent years, various machine learning models have been adopted for speech enhancement. Compared to traditional signal-processing methods, such as Wiener Filter or Spectral Subtraction, the machine learning methods have demonstrated significant improvements, especially for non-stationary noise and low signal-to-noise ratio (SNR) conditions.

Existing machine learning methods for speech detection and enhancement often suffer from speech over-suppression, which can lead to speech distortion or even discontinuity. For example, when speech over-suppression occurs, the voice could fall off too sharply to sound natural, which could be a problem especially in the presence of non-stationary noise or under low SNR conditions. In addition, over-suppression can eliminate or reduce unvoiced sounds or high-frequency fricative voices, which share characteristics with noise. Over-suppression can also eliminate or reduce laughter or applause events, which still constitute non-noise signals but similarly share characteristics with noise.

It would be helpful to improve traditional machine learning methods for speech enhancement, including mitigating speech over-suppression issues, in stored audio content or real-time communication.

### SUMMARY

A computer-implemented method of mitigating over-suppression of speech is disclosed. The method comprises receiving, by a processor, audio data as a joint time-frequency representation over a plurality of frames and a plurality of frequency bands. The method comprises executing a digital model for detecting speech on features of the audio data, the digital model being trained with a loss function with non-linear penalty that penalizes speech over-suppression more than speech under-suppression, and the digital model configured to produce a mask of estimated mask values indicating an amount of speech present for each frame of the plurality of frames and each frequency band of the plurality of frequency bands. The method further comprises transmitting information regarding the mask to a device.

Techniques described in this specification can be advantageous over conventional audio processing techniques. For example, the method improves audio quality by reducing noise, retaining and sharpening speech, such as high-frequency fricative voices and low-level filled pauses, and also retaining other non-noise signals, such as laughter or applause. The improved audio quality leads to better perception of the audio and better user enjoyment of the audio.

### BRIEF DESCRIPTION OF THE DRAWINGS

The example embodiment(s) of the present invention are illustrated by way of example, and not in way by limitation, in the figures of the accompanying drawings and in which like reference numerals refer to similar elements and in which:

FIG. 1 illustrates an example networked computer system in which various embodiments may be practiced.

FIG. 2 illustrates example components of an audio management computer system in accordance with the disclosed embodiments.

FIG. 3 illustrates the relationship between the dependent variable and the independent variable in a perceptual loss function.

FIG. 4 illustrates an example process performed by an audio management computer system in accordance with some embodiments described herein.

FIG. 5 is a block diagram that illustrates a computer system upon which an embodiment of the invention may be implemented.

### DESCRIPTION OF THE EXAMPLE EMBODIMENTS

In the following description, for the purposes of explanation, numerous specific details are set forth in order to provide a thorough understanding of the example embodiment(s) the present invention. It will be apparent, however, that the example embodiment(s) may be practiced without these specific details. In other instances, well-known structures and devices are shown in block diagram form in order to avoid unnecessarily obscuring the example embodiment(s).

Embodiments are described in sections below according to the following outline:
1. GENERAL OVERVIEW
2. EXAMPLE COMPUTING ENVIRONMENTS
3. EXAMPLE COMPUTER COMPONENTS
4. FUNCTIONAL DESCRIPTIONS
   4.1. MODEL TRAINING FOR SPEECH ENHANCEMENT
      4.1.1. FEATURE EXTRACTION
      4.1.2. MACHINE LEARNING MODEL
      4.1.3. PERCEPTUAL LOSS FUNCTION
   4.2. MODEL TRAINING FOR LAUGHTER AND APPLAUSE DETECTION
   4.3. MODEL EXECUTION FOR SPEECH ENHANCEMENT
   4.4. POST-PROCESSING OF TIME-FREQUENCY MASKING
5. EXAMPLE PROCESSES
6. HARDWARE IMPLEMENTATION
7. EXTENSIONS AND ALTERNATIVES

### 1. General Overview

A system for mitigating over-suppression of speech and other non-noise signals is disclosed. In some embodiments, a system is programmed to train a first machine learning model for speech detection or enhancement using a non-linear, asymmetric loss function that penalizes speech over-suppression more than speech under-suppression. The first machine learning model is configured to receive an audio signal and generate a mask indicating an amount of speech present in the audio signal. The mask can be adjusted to remedy sharp voice decay resulting from speech over-suppression. The system is also programmed to train a second machine learning model for laughter or applause detection. The system is further programmed to improve the quality of a new audio signal by applying an adjusted mask to the new audio signal except for the portions of the audio signal that have been identified as corresponding to laughter or applause.

In some embodiment, the system is programmed to receive a training dataset of audio signals in the time domain. The audio signals include different mixtures of speech and non-speech, such as laughter, applause, reverberation, or noise. The system is programmed to extract first features from the audio signals for training a first machine learning model to detect speech. Each audio signal can be converted to a joint time-frequency (T-F) representation having energy values over a plurality of frequency bands and a plurality of frames, and the first features can be computed from the energy values. The system is programmed to further train the first machine learning model, such as an artificial neural network (ANN), based on the first features using a non-linear, asymmetric loss function that penalizes speech over-suppression more than speech under-suppression. The first machine learning model is configured to generate a mask indicating an amount of speech in each frequency band at each frame. The mask is expected to suffer less from speech over-suppression than it would have been if the first machine learning model was trained with a symmetric loss function.

In some embodiments, the system is programmed to extract second features from the same or a separate training dataset of audio signals for training a second machine learning model for identifying laughter or applause, which could be mistaken for noise by the first machine learning model. Each audio signal can be converted to the frequency domain, and the second features can be computed using signal processing methods directly from the audio signal in the time domain or from the converted audio signal in the frequency domain. The system is programmed to further train the second machine learning model, which is typically a classification method, based on the second features.

In some embodiments, given a new audio signal, the system is programmed to estimate an amount of speech present in the new audio signal using the first machine learning model. The system can also be programmed to determine whether any portion of the new audio signal corresponds to laughter or applause using the second machine learning model. The system can then be programmed to bypass mask values generated by the first machine learning model for those portions of the new audio signal identified as corresponding to laughter or applause. In addition, the system can be programmed to determine whether the mask values indicate any sharp voice decay as a product of speech over-suppression despite the use of the asymmetric loss function and adjust the mask values as appropriate.

The system produces technical benefits. The system addresses the technical problem of speech over-suppression in audio processing. The system improves audio quality by reducing noise, retaining and sharpening speech, such as high-frequency fricative voices and low-level filled pauses, and also retaining other non-noise signals, such as laughter or applause. The improved audio quality leads to better perception of the audio and better user enjoyment of the audio.

### 2. Example Computing Environments

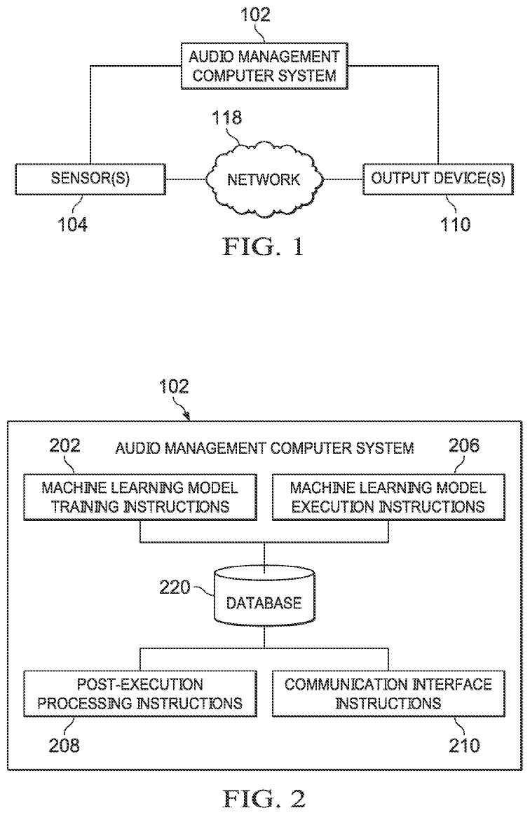

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises an audio management server computer 102 (“server”), one or more sensors 104 or input devices, and one or more output devices 110, which are communicatively coupled through direct physical connections or via one or more networks 118.

In some embodiments, the server 102 broadly represents one or more computers, virtual computing instances, and/or instances of an application that is programmed or configured with data structures and/or database records that are arranged to host or execute functions related to mitigating speech over-suppression. The server 102 can comprise a server farm, a cloud computing platform, a parallel computer, or any other computing facility with sufficient computing power in data processing, data storage, and network communication for the above-described functions.

In some embodiments, each of the one or more sensors 104 can include a microphone or another digital recording device that converts sounds into electric signals. Each sensor is configured to transmit detected audio data to the server 102. Each sensor may include a processor or may be integrated into a typical client device, such as a desktop computer, laptop computer, tablet computer, smartphone, or wearable device.

In some embodiments, each of the one or more output devices 110 can include a speaker or another digital playing device that converts electrical signals back to sounds. Each output device is programmed to play audio data received from the server 102. Similar to a sensor, an output device may include a processor or may be integrated into a typical client device, such as a desktop computer, laptop computer, tablet computer, smartphone, or wearable device.

The one or more networks 118 may be implemented by any medium or mechanism that provides for the exchange of data between the various elements of FIG. 1. Examples of the networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the server 102 is programmed to receive input audio data corresponding to sounds in a given environment from the one or more sensors 104. The input audio data may comprise a plurality of frames over time. The sever 102 is programmed to next process the input audio data, which typically corresponds to a mixture of speech and noise, to estimate how much speech is present (or detect the amount of speech) in each frame of the input audio data. The server is further programmed to mitigate potential speech over-suppression in estimating how much speech is present. The server is programmed to send the final detection results to another device for downstream processing. The server can also be programmed to update the input audio data based on the final detection results estimates to produce cleaned-up output audio data expected to contain less noise than the input audio data, and send the output audio data to the one or more output devices.

### 3. Example Computer Components

FIG. 2 illustrates example components of an audio management computer system in accordance with the disclosed embodiments. The figure is for illustration purposes only and the server 102 can comprise fewer or more functional or storage components. Each of the functional components can be implemented as software components, general or specific-purpose hardware components, firmware components, or any combination thereof. Each of the functional components can also be coupled with one or more storage components (not shown). A storage component can be implemented using any of relational databases, object databases, flat file systems, or Javascript Object Notation (JSON) stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 comprises machine learning model training instructions 202, machine learning model execution instructions 206, post-execution processing instructions 208, and communication interface instructions 210. The server 102 also comprises a database 220.

In some embodiments, the machine learning model training instructions 202 enable training machine learning models for detection of speech and other non-noise signals. The machine learning models can include various neural networks or other classification models. The training can include extracting features from training audio data, feeding given or extracted features optionally with expected model output to a training framework to train a machine learning model, and storing the trained machine learning model. The expected model output for a first machine learning model could indicate the amount of speech present in each given audio segment. The training framework can include an objective function designed to mitigate speech over-suppression. The expected model output for a second machine learning model could indicate whether each given audio segment corresponds to laughter or applause.

In some embodiments, the machine learning model execution instructions 206 enable executing machine learning models for detection of speech or other non-noise signals. The execution can include extracting features from a new audio segment, feeding the extracted features to a trained machine learning model, and obtaining new output from executing the trained machine learning model. For the first machine learning model, the new output can indicate the amount of speech in the new audio segment. For the second machine learning model, the new output can indicate whether the new audio segment corresponds to laughter or applause.

In some embodiments, the post-execution processing instructions 208 enable additional processing to determine whether or how to adjust the new output generated by the first machine learning model, which can be in the form of a mask indicating an amount of present in the new audio segment. The additional processing can include bypassing or turning off the mask values of the mask for those portions of the new audio segment deemed to correspond to laughter or applause based on the new output generated by the second machine learning model. The additional processing can also include updating the mask values that corresponds to a sharp voice decay.

In some embodiments, the communication interface instructions 210 enable communication with other systems or devices through computer networks. The communication can include receiving audio data or trained machine learning models from audio sources or other systems. The communication can also include transmitting speech detection or enhancement results to other processing devices or output devices.

In some embodiments, the database 220 is programmed or configured to manage storage of and access to relevant data, such as received audio data, digital models, features extracted from received audio data, or results of executing the digital models.

### 4. Functional Descriptions

### 4.1. Model Training for Speech Enhancement

### 4.1.1. Feature Extraction

In some embodiments, the server 102 receives a training dataset of audio segments in the time domain. Each audio segment comprises a waveform over a plurality of frames and can be converted into a joint time-frequency (T-F) representation using a spectral transform, such as the short-term Fourier Transform (STFT), shifted modified discrete Fourier Transform (MDFT), or complex quadratic mirror filter (CQMF). The joined T-F representation covers a plurality of frames and a plurality of frequency bins.

In some embodiments, the server 102 converts the T-F representation into a vector of banded energies, for 56 perceptually motivated bands, for example. Each perceptually motivated band is typically located in a frequency domain that matches how a human ear processes speech, such as from 120 Hz to 2,000 Hz, so that capturing data in these perceptually motivated band means not losing speech quality to a human ear. More specifically, the squared magnitudes of the output frequency bins of the spectral transform are grouped into perceptually motivated bands, where the number of frequency bins per band increases at higher frequencies. The grouping strategy may be “soft” with some spectral energy being leaked across neighboring bands or “hard” with no leakage across bands. Specifically, when the bin energies of a noisy frame are represented by x being a column vector of size p by 1, where p denotes the number of bins, the conversion to a vector of banded energies could be performed by computing y=W*x, where y is a column vector of size q by 1 representing the band energies for this noisy frame, W is a banding matrix of size q by p, and q denotes the number of perceptually motivated bands.

In some embodiments, the server 102 can then compute the logarithm of each banded energy as a feature value for each frame and each frequency band. For each joint T-F representation, the server 102 can thus obtain an input feature vector comprising feature values for the plurality of frames and the plurality of frequency bands.

In some embodiments, for supervised learning, the server 102 computes, for each joint T-F representation, an expected mask indicating an amount of speech present for each frame and each frequency band. The mask can be in the form of the logarithm of the ratio of the speech energy and the sum of the speech and noise energies. The server 102 can include the expect masks in the training dataset.

### 4.1.2. Machine Learning Model

In some embodiments, the server 102 builds a machine learning model for speech enhancement using the training dataset. The machine learning model can be an ANN, such as those disclosed in co-pending U.S. Patent Application No. 63/221,629 (LensNet), filed on Jul. 14, 2021, or in co-pending U.S. Patent Applications No. 63/260,203 and 63/260,201 (CGRU). LensNet is a deep noise suppression model, and CGRU is a deep de-noise and de-reverb model. The machine learning model is configured to produce, for a joint T-F representation, an estimated mask indicating an amount of speech present for each frame and each frequency band of the joint T-F representation.

LensNet is a neural network model that takes banded energies corresponding to an original noisy waveform and produces a speech value indicating the amount of speech present in each frequency band at each frame. These speech values can be used to suppress noise by reducing the frequency magnitudes in those frequency bands where speech is less likely to be present. The neural network model has low latency and can be used for real-time noise suppression. The neural network model comprises a feature extraction block that implements some lookahead. The feature extraction block is followed by an encoder with steady down-sampling along the frequency dimension forming a contracting path. Convolution is performed along the contracting path with increasingly larger dilation factors along the time dimension. The encoder is followed by a corresponding decoder with steady up-sampling along the frequency dimension forming an expanding path. The decoder receives scaled output feature maps from the encoder at a corresponding level so that features extracted from different receptive fields along the frequency dimension can all be considered in determining how much speech is present in each frequency band at each frame.

CGRU comprises a convolutional block and a gated recurrent unit (GRU). The convolutional block contains dilated convolutional layers with increasing dilation rates (e.g., 1, 2, 4, 8, 12, 20) followed by dilated convolutional layers with decreasing dilation rates (e.g., 12, 8, 4, 2, 1) followed by convolutional layers. Convolutional layers having the same dilated rate are added or connected when dilation rates are decreasing. The output of the GRU is also connected to the convolutional layers with decreasing dilation rates. The convolutional block of convolutional layers with different dilation rates allows learning features of spectral signals at different resolutions, and the GRU allows stabilizing and smoothing the output masks.

### 4.1.3. Perceptual Loss Function

In some embodiments, the server 102 trains the machine learning model using an appropriate optimization method known to someone skilled in the art. The optimization method, which is often iterative in nature, can minimize a loss (or cost) function that measures an error of the current estimate from the ground truth. For an ANN, the optimization method can be stochastic gradient descent, where the weights are updated using the backpropagation of error algorithm.

Traditionally, the objective function or loss function, such as the mean squared error (MSE), does not reflect human auditory perception well. A processed speech segment with a small MSE does not necessarily have high speech quality and intelligibility. Specifically, the objective function does not differentiate negative detection errors (false negatives, speech over-suppression) from positive detection errors (false positives, speech under-suppression), even if speech over-suppression may have a greater perceptual effect than speech under-suppression and is often treated differently from speech under-suppression in speech enhancement applications.

Speech over-suppression can hurt speech quality or intelligibility more than speech under-suppression. Speech over-suppression occurs when a predicted (estimated) mask value is less than the ground-truth mask value, as less speech is being predicted than the ground truth and thus more speech is being suppressed than necessary.

In some embodiments, a perceptual cost function that discourages speech over-suppression is used in the optimization method to train the machine learning model. The perceptual cost function is non-linear with asymmetric penalty for speech over-suppression and speech under-suppression. Specifically, the cost function assigns more penalty to a negative difference between the predicted mask value and the ground-truth mask value and less penalty to a positive difference. Experimental evaluations with CGRU and LensNet show that the perceptual loss function performs better than the MSE, for example, in reducing over-suppression on high-frequency fricative voices and low-level filled pauses, such as “um” and “uh”.

In some embodiments, the perceptual loss function Loss is defined as follows:

$$diff = {y}_{target}^{p} - {y}_{predicted}^{p} \qquad ( 1 )$$

$$Loss = {m}^{diff} - diff - 1 , \qquad ( 2 )$$

where y_{taregt} is the target (ground truth) mask value for a frame and a frequency band, y_{predicted} is the predicted mask value for the frame and the frequency band, m is a tuning parameter that can control the shape of the asymmetric penalty, and p is the power-law term or the scaling exponent. For example, m can be 2.6, 2.65, 2.7, etc. and p can be 0.5, 0.6, 0.7, etc. As y_{predicted} or y_{target} is less than one, such fractional values that are not overly small (e.g., that are greater than 0.5) for p tend to amplify smaller values for y_{predicted} more than larger values for y_{predicted} or y_{target}. Such fractional values for p tend to further render the difference between y_{taget}^{p} and y_{predicted}^{p} larger than the difference between y_{target} and y_{predicted}. A small value for y_{predicted} might have been the result of starting with a noisy frame, which corresponds to a small value of y_{taregt}, and continuing with over-suppression, which leads to an even smaller value for y_{predicted}. When the difference between y_{taregt} and y_{predicted} is amplified into the difference between y_{taregt}^{p} and y_{predicted}^{p} when appropriate (using overly small values for p might lead to over-frequent amplification), such speech over-suppression is penalized more. Therefore, the power law terms may especially help ameliorate speech over-suppression for the difficult cases of noisy frames. Such inherent focus on difficult cases also leads to the possibility to have a smaller machine learning model with fewer parameters. The total loss for an audio signal that corresponds to a plurality of frequency bands and a plurality of frames could be computed as the sum or average of the loss values over the plurality of frequency bands and the plurality of frames.

FIG. 3 illustrates the relationship between the dependent variable and the independent variable in the perceptual loss function defined by equations (1) and (2). Loss corresponds to the y-axis 304, and diff corresponds to the x-axis 302. When diff is equal to 0, the target mask value is equal to the predicted mask value indicating no speech suppression. In this case, Loss has the smallest value of 0. When diff is a negative value, as is the case at point 310, the target mask value is smaller than the predicted mask value indicating speech under-suppression. When diff is a positive value, as is the case at point 308, the target mask value is greater than the predicted mask value indicating speech over-suppression. As can be seen in FIG. 3, Loss increases faster as diff goes from 0 to a positive value than it decreases as diff goes from 0 to a negative value. With this perceptual loss function, an optimization method based on gradient descent is expected to quickly descend from a positive diff value and thus stay away from speech over-suppression.

In some embodiments, the perceptual loss function Loss is based on the MSE as follows:

$$diff = {y}_{target}^{p} - {y}_{predicted}^{p} \qquad ( 3 )$$

$$w = {m}^{diff} - diff - 1 \qquad ( 4 )$$

$$Loss = w * {diff}^{2} , \qquad ( 5 )$$

With the MSE, positive diff values and negative diff values are penalized equally, and so negative diff values indicating speech over-suppression are not penalized more than the positive diff values indicating speech under-suppression. With Loss defined by equation (5), significant speech under-suppression corresponding to a predicted mask value much lower than the target mask value is now punished multiple times, through w (a corresponding large weight) and through diff² (a corresponding large error).

The proposed perceptual loss functions can be used for any machine learning model configured to perform time-frequency masking for speech detection or enhancement. The specific purpose of the machine learning model can be noise reduction, echo suppression, speech dereverberation, or joint noise and reverb management. For deep learning models, such a perceptual loss function is generally used in the model training stage. For other machine learning models, such a perceptual loss function may be used in the model execution stage.

### 4.2. Model Training for Laughter and Applause Detection

Applause and laughter frequently occur in meetings and provide significant sentiment cues. However, many speech enhancement systems based on deep learning suffer from over-suppression of such non-noise signals.

In some embodiments, the server 102 detects laughter and applause using machine learning techniques. The server 102 can start with a training dataset of feature vectors or audio signals from which to compute feature vectors. The feature vectors represent varying amounts of laughter or applause in some frames, where the laughter or applause would generally be the dominant audio in certain frequency bands. The server 102 can compute feature vectors using signal processing methods. The features that are helpful for identifying laughter or applause include the Mel-frequency Cepstral Coefficients (MFCC) or Delta Mel-frequency Cepstral Coefficients applied to audio data in the frequency domain (which can be converted from the initial time domain). The features also include the amplitude modulation spectrum (AMS), pitch, or rhythm applied to audio data in the time domain. All these feature values computed for each frequency band or each frame of an audio signal can be combined into a feature vector. The training dataset can also include a classification label for each audio signal indicating whether the audio signal corresponds to laughter or applause or not. Alternatively, each audio signal could be similarly converted to a joint time-frequency representation over a plurality of frequency bands and a plurality of frames, the time-based features could be used for all frequency bands, the frequency-based features could be used for all frames, and the training dataset can include a classification label per frequency band and per frame.

In some embodiments, the server 102 can build a machine learning model for classifying an audio signal into laughter or applause or otherwise using an appropriate training algorithm based on the training dataset. The machine learning model can be the adaptive boosting algorithm, Support Vector Machine (SVM), random forest, Gaussian Mixture Model (GMM), Deep Neural Network (DNN), or another classification method known to someone skilled in the art.

### 4.3. Model Execution for Speech Enhancement

In some embodiments, the server 102 receives a new audio signal having one or more frames in the time domain. The server 102 then applies the machine learning approach discussed in Section 4.1. to the new audio signal to generate the predicted mask indicating an amount of speech present for each frame and each frequency band in the corresponding T-F representation. The application includes converting the new audio signal to the joint T-F representation that initially covers a plurality of frames and a plurality of frequency bins.

In some embodiments, the server 102 further generates an improved audio signal for the new audio signal based on the predicted mask. This step can alternatively be performed after the predicted mask is adjusted in a post-processing stage, as further discussed in Section 4.4. Given a band mask for y (obtained from applying the machine learning approach discussed in Section 4.1) as a column vector m_band of size q by 1, where y is a column vector of size q by 1 representing band energies for an original noisy frame, q denotes the number of perceptually motivated bands, the conversion to the bin masks can be performed by computing m_bin=W_transpose*m_band, where m_bin is a column vector of size p by 1, p denotes the number of bins, and W_transpose of size of p by q is the transpose of W, a banding matrix of size q by p.

In some embodiments, the server 102 can multiply the original frequency bin magnitudes in the joint T-F representation by the bin mask values to effect the masking or reduction of noise and obtain an estimated clean spectrum. The server 102 can further convert the estimated clean spectral spectrum back to a waveform as an enhanced waveform (over the noise waveform), which could be communicated via an output device, using any method known to someone skilled in the art, such as an inverse CQMF.

### 4.4. Post-Processing of Time-Frequency Masking

In some embodiments, the server 102 adjusts the predicted mask outputted from the machine learning model for speech detection or enhancement in a post-processing stage to further reduce over-suppression of non-noise signals.

In some embodiments, the server 102 separately applies the machine learning approach discussed in Section 4.2 to the new audio signal to determine whether the new audio signal contains laughter or applause, as a whole or at specific frequency bands and frames. In response to a positive determination, the server 102 can ignore the predicted mask for this audio signal or the particular frequency band and frame, or set the predicted mask to indicate full speech, to avoid suppressing laughter or applause. The server 102 can also perform smoothing or additional processing on the resulting mask so that the final mask can lead to audio that sounds as natural as possible.

As noted above, speech over-suppression can lead to speech distortion or even discontinuity. For example, when speech over-suppression occurs, the voice could fall off too sharply to sound natural, which could be a problem especially in the presence of non-stationary noise or under low SNR conditions. In some embodiments, the server 102 can apply an existing voice activity detection algorithm using the mask to identify a voice decay period where the voice falls off or simply examine the mask in the time domain to identify a voice decay period where the mask value generally decreases. Such a voice decay period generally corresponds to the speech-to-noise transition at the ending part of a speech talk-spurt. The server 102 can then compute the mask attenuation specifically for that voice decay period to determine whether the mask leads to any discontinuity or abrupt change in the amount of speech during the voice decay period. For example, the log energy difference between adjacent frames can be computed, and a difference larger than a threshold, such as 30 dB or 40 dB, can be viewed as an abrupt change. In response to any detected discontinuity or abrupt change, the server 102 can adjust the predicted mask such that the mask attenuation would match the typical voice decay rate of a small room, such as 200 ms reverberation time (the time it takes for a sound to decay by 60 dB, sometimes abbreviated T60 or RT60). The adjustment can be performed on the mask values by a combination of interpolation, smoothing, recursive averaging, or similar techniques.

### 5. Example Processes

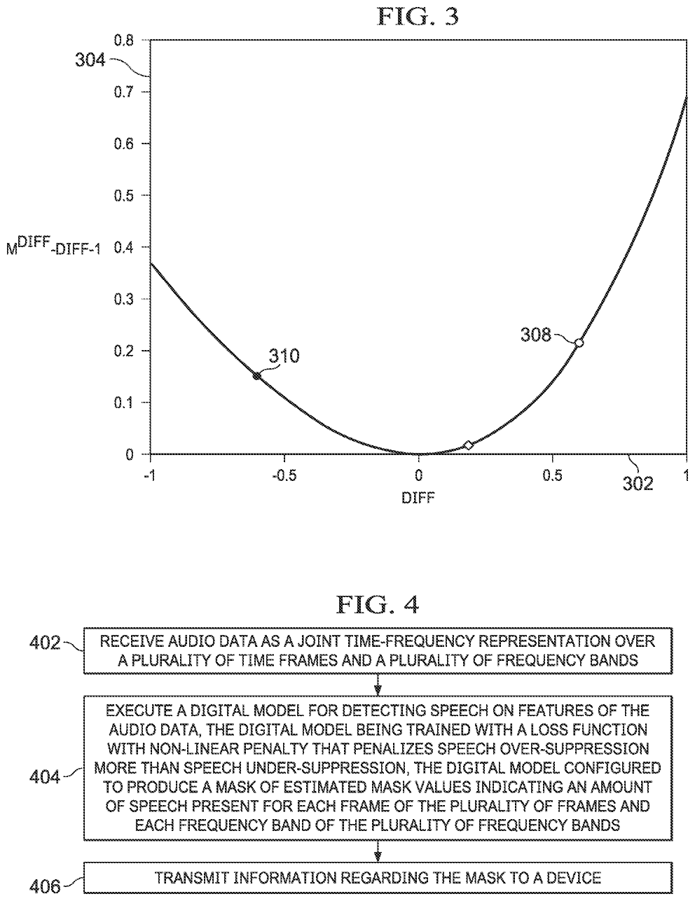

FIG. 4 illustrates an example process performed by an audio management computer system in accordance with some embodiments described herein. FIG. 4 is shown in simplified, schematic format for purposes of illustrating a clear example and other embodiments may include more, fewer, or different elements connected in various manners. FIG. 4 is each intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 402, the server 102 is programmed to receive audio data as a joint time-frequency representation over a plurality of frames and a plurality of frequency bands.

In some embodiments, the server 102 is programmed to receive an input waveform in a time domain. The server 102 is programmed to transform the input waveform into raw audio data over a plurality of frequency bins and the plurality of frames. The server 102 is programmed to then convert the raw audio data into the audio data by grouping the plurality of frequency bins into the plurality of frequency bands.

In some embodiments, the joint time-frequency representation has an energy value for each time frame and each frequency band. The server 102 is further programmed to compute a logarithm of each energy value in the joint time-frequency representation as a feature of the features.

In step 404, the server 102 is programmed to execute a digital model for detecting speech on features of the audio data. The digital model is trained with a loss function with non-linear penalty that penalizes speech over-suppression more than speech under-suppression and configured to produce a mask of estimated mask values indicating an amount of speech present for each frame of the plurality of frames and each frequency band of the plurality of frequency bands.

In some embodiments, the digital model is an ANN including a DNN trained using a training dataset of joint time-frequency representations of different mixtures of speech and non-speech. In some embodiments, the loss function being m^{diff}−diff−1, wherein diff denotes the difference between a target mask value raised to a power and an estimated mask value of the estimated mask values raised to the power, and m denotes a tuning parameter. In other embodiments, the loss function being w*diff², wherein w=m^{diff}−diff−1, diff denotes the difference between a target mask value raised to a power and an estimated mask value of the estimated mask values raised to the power, and m denotes a tuning parameter.

In some embodiments, the server 102 is programmed to compute a mask attenuation for the mask and determine whether the mark attenuation corresponds to a fall-off amount that exceeds a threshold. In response to determining that the mask attenuation corresponds to a fall-off amount that exceeds the threshold, the server 102 is programmed to adjust the mask such that the mask attenuation matches a predetermined voice decay rate. The predetermine voice decay rate can be 200 ms reverberation time.

In step 406, the server 102 is programmed to transmit information regarding the mask to a device.

In some embodiments, the server 102 is programmed to determine whether the audio data corresponds to laughter or applause. Specifically, the server 102 is programmed to compute derived features of the audio data in a time domain and a frequency domain, and execute a second digital model for classifying the audio data into laughter or applause or otherwise based on the derived features. In response to determining that the audio data corresponds to laughter or applause, the server 102 is programmed to further transmit an alert to ignore the mask.

In some embodiments, the server 102 is programmed to perform inverse banding on the estimated mask values to generate updated mask values for each frequency bin of the plurality of frequency bins and each frame of the plurality of frames. The server 102 is programmed to apply the updated mask values to the raw audio data to generate new output data. The server 102 is programmed to then transform the new output data into an enhanced waveform.

### 6. Hardware Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

Various aspects of the disclosed embodiments may be appreciated from the following enumerated example embodiments (EEEs):

EEE1. A computer-implemented method of mitigating over-suppression of speech, comprising: receiving, by a processor, audio data as a joint time-frequency representation over a plurality of frames and a plurality of frequency bands; executing a digital model for detecting speech on features of the audio data, the digital model being trained with a loss function with non-linear penalty that penalizes speech over-suppression more than speech under-suppression, the digital model configured to produce a mask of estimated mask values indicating an amount of speech present for each frame of the plurality of frames and each frequency band of the plurality of frequency bands; and transmitting information regarding the mask to a device.

EEE 2. The computer-implemented method of claim 1, the loss function being m^{diff}−diff−1, and wherein diff denotes a difference between a target mask value with a power-law term and an estimated mask value of the estimated mask values with the power-law term, and m denotes a tuning parameter.

EEE 3. The computer-implemented method of claim 1, the loss function being w*diff², and wherein w m diff diff 1, diff denotes a difference between a target mask value raised to a power and an estimated mask value of the estimated mask values raised to the power, and m denotes a tuning parameter.

EEE 4. The computer-implemented method of any of claims 1-3, the joint time-frequency representation having an energy value for each time frame and each frequency band, the method further comprising computing a logarithm of each energy value in the joint time-frequency representation as a feature of the features.

EEE 5. The computer-implemented method of any of claims 1-4, the digital model being an artificial neural network trained using a training dataset of joint time-frequency representations of different mixtures of speech and non-speech.

EEE 6. The computer-implemented method of any of claims 1-5, further comprising: determining whether the audio data corresponds to laughter or applause; and in response to determining that the audio data corresponds to laughter or applause, further transmitting an alert to ignore the mask.

EEE 7. The computer-implemented method of any of claims 1-6, computing derived features of the audio data in a time domain and a frequency domain; and executing a second digital model for classifying the audio data into laughter or applause or otherwise based on the derived features.

EEE 8. The computer-implemented method of any of claims 1-7, further comprising: computing a mask attenuation for the mask: determining whether the mask attenuation corresponds to a fall-off amount that exceeds a threshold; and in response to determining that the mask attenuation corresponds to a fall-off amount that exceeds the threshold, adjusting the mask such that the mask attenuation matches a predetermined voice decay rate.

EEE 9. The computer-implemented method of claim 8, the predetermine voice decay rate being 200 ms reverberation time.

EEE 10. The computer-implemented method of any of claims 1-9, further comprising: receiving an input waveform in a time domain: transforming the input waveform into raw audio data over a plurality of frequency bins and the plurality of frames; and converting the raw audio data into the audio data by grouping the plurality of frequency bins into the plurality of frequency bands.

EEE 11. The computer-implemented method of claim 10, further comprising: performing inverse banding on the estimated mask values to generate updated mask values for each frequency bin of the plurality of frequency bins and each frame of the plurality of frames; applying the updated mask values to the raw audio data to generate new output data; and transforming the new output data into an enhanced waveform.

EEE 12. A system for mitigating over-suppression of speech, comprising: a memory; and one or more processors coupled to the memory and configured to perform: receiving, by a processor, audio data as a joint time-frequency representation over a plurality of frames and a plurality of frequency bands; executing a digital model for detecting speech on features of the audio data, the digital model being trained with a loss function with non-linear penalty that penalizes speech over-suppression more than speech under-suppression, the digital model configured to produce a mask of estimated mask values indicating an amount of speech present for each frame of the plurality of frames and each frequency band of the plurality of frequency bands; and transmitting information regarding the mask to a device.

EEE 13. A computer-readable, non-transitory storage medium storing computer-executable instructions, which when executed implement a method of mitigating over-suppression of speech, the method comprising: receiving, by a processor, a training dataset of a plurality of joint time-frequency representations: creating a digital model for detecting speech from the training dataset using a loss function with non-linear penalty that penalizes speech over-suppression more than speech under-suppression, the digital model configured to produce a mask for in audio data over a plurality of frequency bands and a plurality of frames, the mask including one estimated mask value indicating an amount of detected speech in each frequency band of the plurality of frequency bands at each frame of the plurality of frames: receiving new audio data: executing a digital model for detecting speech on features of the new audio data to obtain a new mask; and transmitting information regarding the new mask to a device.

EEE 14. The computer-readable, non-transitory storage medium of claim 13, the loss function being m^{diff}−diff−1, and wherein diff denotes a difference between a target mask value raised to a power and an estimated mask value of the estimated mask values raised to the power, and m denotes a tuning parameter.

EEE 15. The computer-readable, non-transitory storage medium of claim 13, the loss function being w*diff², and wherein w=m^{diff}−diff−1, diff denotes a difference between a target mask value raised to a power and an estimated mask value of the estimated mask values raised to the power, and m denotes a tuning parameter.

EEE 16. The computer-readable, non-transitory storage medium of any of claims 13-15, the method further comprising: determining whether the audio data corresponds to laughter or applause; and in response to determining that the audio data corresponds to laughter or applause, further transmitting an alert to ignore the mask.

EEE 17. The computer-readable, non-transitory storage medium of any of claims 13-16, the method further comprising: computing derived features of the audio data in a time domain and a frequency domain; and executing a second digital model for classifying the audio data into laughter or applause or otherwise based on the derived features.

EEE 18. The computer-readable, non-transitory storage medium of any of claims 13-17, the method further comprising: computing a mask attenuation for the mask: determining whether the mask attenuation corresponds to a fall-off amount that exceeds a threshold; and in response to determining that the mask attenuation corresponds to a fall-off amount that exceeds the threshold, adjusting the mask such that the mask attenuation matches a predetermined voice decay rate.

EEE 19. The computer-readable, non-transitory storage medium of any of claims 13-18, the method further comprising: receiving an input waveform in a time domain: transforming the input waveform into raw audio data over a plurality of frequency bins and the plurality of frames; and converting the raw audio data into the audio data by grouping the plurality of frequency bins into the plurality of frequency bands.

EEE 20. The computer-readable, non-transitory storage medium of claim 19, the method further comprising: performing inverse banding on the estimated mask values to generate updated mask values for each frequency bin of the plurality of frequency bins and each frame of the plurality of frames: applying the updated mask values to the raw audio data to generate new output data; and transforming the new output data into an enhanced waveform.

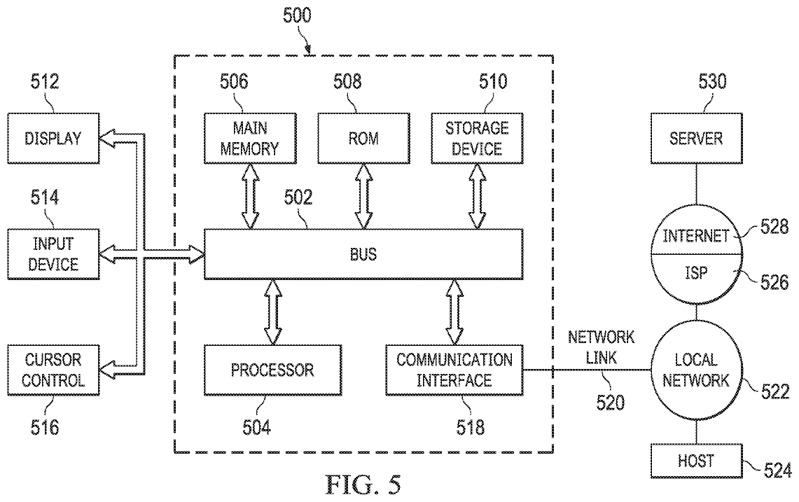

FIG. 5 is a block diagram that illustrates an example computer system with which an embodiment may be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which may include a bus and/or other communication mechanism(s) for communicating information and/or instructions between the components of the computer system 500 over electronic signal paths. The I/O subsystem 502 may include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor or ARM processor. Processor 504 may comprise an integrated arithmetic logic unit (ALU) or may be coupled to a separate ALU.

Computer system 500 includes one or more units of memory 506, such as a main memory, which is coupled to I/O subsystem 502 for electronically digitally storing data and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 may include various forms of programmable ROM (PROM) such as erasable PROM (EPROM) or electrically erasable PROM (EEPROM). A unit of persistent storage 510 may include various forms of non-volatile RAM (NVRAM), such as FLASH memory, or solid-state storage, magnetic disk or optical disk such as CD-ROM or DVD-ROM, and may be coupled to I/O subsystem 502 for storing information and instructions. Storage 510 is an example of a non-transitory computer-readable medium that may be used to store instructions and data which when executed by the processor 504 cause performing computer-implemented methods to execute the techniques herein.

The instructions in memory 506, ROM 508 or storage 510 may comprise one or more sets of instructions that are organized as modules, methods, objects, functions, routines, or calls. The instructions may be organized as one or more computer programs, operating system services, or application programs including mobile apps. The instructions may comprise an operating system and/or system software: one or more libraries to support multimedia, programming or other functions: data protocol instructions or stacks to implement TCP/IP, HTTP or other communication protocols: file processing instructions to interpret and render files coded using HTML, XML, JPEG, MPEG or PNG: user interface instructions to render or interpret commands for a graphical user interface (GUI), command-line interface or text user interface: application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 500 may be coupled via I/O subsystem 502 to at least one output device 512. In one embodiment, output device 512 is a digital computer display. Examples of a display that may be used in various embodiments include a touch screen display or a light-emitting diode (LED) display or a liquid crystal display (LCD) or an e-paper display. Computer system 500 may include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

In another embodiment, computer system 500 may comprise an internet of things (IoT) device in which one or more of the output device 512, input device 514, and control device 516 are omitted. Or, in such an embodiment, the input device 514 may comprise one or more cameras, motion detectors, thermometers, microphones, seismic detectors, other sensors or detectors, measurement devices or encoders and the output device 512 may comprise a special-purpose display such as a single-line LED or LCD display, one or more indicators, a display panel, a meter, a valve, a solenoid, an actuator or a servo.

When computer system 500 is a mobile computing device, input device 514 may comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 may include hardware, software, firmware and interfaces for generating position reporting packets, notifications, pulse or heartbeat signals, or other recurring data transmissions that specify a position of the computer system 500, alone or in combination with other application-specific data, directed toward host 524 or server 530.

Computer system 500 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions may be read into main memory 506 from another storage medium, such as storage 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying at least one sequence of at least one instruction to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage 510 either before or after execution by processor 504.

Computer system 500 also includes a communication interface 518 coupled to bus 502. Communication interface 518 provides a two-way data communication coupling to network link(s) 520 that are directly or indirectly connected to at least one communication networks, such as a network 522 or a public or private cloud on the Internet. For example, communication interface 518 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a local area network (LAN), wide-area network (WAN), campus network, internetwork or any combination thereof. Communication interface 518 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic or optical signals over signal paths that carry digital data streams representing various types of information.

Network link 520 typically provides electrical, electromagnetic, or optical data communication directly or through at least one network to other data devices, using, for example, satellite, cellular, Wi-Fi, or BLUETOOTH technology. For example, network link 520 may provide a connection through a network 522 to a host computer 524.

Furthermore, network link 520 may provide a connection through network 522 or to other computing devices via internetworking devices and/or computers that are operated by an Internet Service Provider (ISP) 526. ISP 526 provides data communication services through a world-wide packet data communication network represented as internet 528. A server computer 530 may be coupled to internet 528. Server 530 broadly represents any computer, data center, virtual machine or virtual computing instance with or without a hypervisor, or computer executing a containerized program system such as DOCKER or KUBERNETES. Server 530 may represent an electronic digital service that is implemented using more than one computer or instance and that is accessed and used by transmitting web services requests, uniform resource locator (URL) strings with parameters in HTTP payloads, application programming interface (API) calls, app services calls, or other service calls. Computer system 500 and server 530 may form elements of a distributed computing system that includes other computers, a processing cluster, server farm or other organization of computers that cooperate to perform tasks or execute applications or services. Server 530 may comprise one or more sets of instructions that are organized as modules, methods, objects, functions, routines, or calls. The instructions may be organized as one or more computer programs, operating system services, or application programs including mobile apps. The instructions may comprise an operating system and/or system software: one or more libraries to support multimedia, programming or other functions; data protocol instructions or stacks to implement TCP/IP, HTTP or other communication protocols: file format processing instructions to interpret or render files coded using HTML, XML, JPEG, MPEG or PNG: user interface instructions to render or interpret commands for a graphical user interface (GUI), command-line interface or text user interface: application software such as an office suite, internet access applications, design and manufacturing applications, graphics applications, audio applications, software engineering applications, educational applications, games or miscellaneous applications. Server 530 may comprise a web application server that hosts a presentation layer, application layer and data storage layer such as a relational database system using structured query language (SQL) or NoSQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage 510, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program: for example, opening up several instances of the same program often means more than one process is being executed. Multitasking may be implemented to allow multiple processes to share processor 504. While each processor 504 or core of the processor executes a single task at a time, computer system 500 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A computer-implemented method of mitigating over-suppression of speech, comprising:
receiving, by a processor, audio data as a joint time-frequency representation over a plurality of frames and a plurality of frequency bands;
executing a digital model for detecting speech on features of the audio data,
the digital model being trained with a loss function with non-linear penalty that penalizes speech over-suppression more than speech under-suppression,
the digital model configured to produce a mask of estimated mask values indicating an amount of speech present for each frame of the plurality of frames and each frequency band of the plurality of frequency bands; and
transmitting information regarding the mask to a device.

2. The computer-implemented method of claim 1,
the loss function being m^{diff}−diff−1, and
wherein diff denotes a difference between a target mask value with a power-law term and an estimated mask value of the estimated mask values with the power-law term, and m denotes a tuning parameter.

3. The computer-implemented method of claim 1,
the loss function being w*diff², and
wherein w=m^{diff}−diff−1, diff denotes a difference between a target mask value raised to a power and an estimated mask value of the estimated mask values raised to the power, and m denotes a tuning parameter.

4. The computer-implemented method of claim 1,
the joint time-frequency representation having an energy value for each time frame and each frequency band,
the method further comprising computing a logarithm of each energy value in the joint time-frequency representation as a feature of the features.

5. The computer-implemented method of claim 1, the digital model being an artificial neural network trained using a training dataset of joint time-frequency representations of different mixtures of speech and non-speech.

6. The computer-implemented method of claim 1, further comprising:
determining whether the audio data corresponds to laughter or applause; and
in response to determining that the audio data corresponds to laughter or applause, further transmitting an alert to ignore the mask.

7. The computer-implemented method of claim 1,
computing derived features of the audio data in a time domain and a frequency domain; and
executing a second digital model for classifying the audio data into laughter or applause or otherwise based on the derived features.

8. The computer-implemented method of claim 1, further comprising:
computing a mask attenuation for the mask;
determining whether the mask attenuation corresponds to a fall-off amount that exceeds a threshold; and
in response to determining that the mask attenuation corresponds to a fall-off amount that exceeds the threshold, adjusting the mask such that the mask attenuation matches a predetermined voice decay rate.

9. The computer-implemented method of claim 8, the predetermined voice decay rate being 200 ms reverberation time.

10. The computer-implemented method of claim 1, further comprising:
receiving an input waveform in a time domain;
transforming the input waveform into raw audio data over a plurality of frequency bins and the plurality of frames; and
converting the raw audio data into the audio data by grouping the plurality of frequency bins into the plurality of frequency bands.

11. The computer-implemented method of claim 10, further comprising:
performing inverse banding on the estimated mask values to generate updated mask values for each frequency bin of the plurality of frequency bins and each frame of the plurality of frames;
applying the updated mask values to the raw audio data to generate new output data; and
transforming the new output data into an enhanced waveform.

12. A system for mitigating over-suppression of speech, comprising:
a memory; and
one or more processors coupled to the memory and configured to perform:
receiving, by a processor, audio data as a joint time-frequency representation over a plurality of frames and a plurality of frequency bands;
executing a digital model for detecting speech on features of the audio data,
the digital model being trained with a loss function with non-linear penalty that penalizes speech over-suppression more than speech under-suppression,
the digital model configured to produce a mask of estimated mask values indicating an amount of speech present for each frame of the plurality of frames and each frequency band of the plurality of frequency bands; and
transmitting information regarding the mask to a device.

13. A computer-readable, non-transitory storage medium storing computer-executable instructions, which when executed implement a method of mitigating over-suppression of speech, the method comprising:
receiving, by a processor, a training dataset of a plurality of joint time-frequency representations;
creating a digital model for detecting speech from the training dataset using a loss function with non-linear penalty that penalizes speech over-suppression more than speech under-suppression,
the digital model configured to produce a mask for in audio data over a plurality of frequency bands and a plurality of frames,
the mask including one estimated mask value indicating an amount of detected speech in each frequency band of the plurality of frequency bands at each frame of the plurality of frames;
receiving new audio data;
executing a digital model for detecting speech on features of the new audio data to obtain a new mask; and
transmitting information regarding the new mask to a device.

14. The computer-readable, non-transitory storage medium of claim 13,
the loss function being m^{diff}−diff−1, and
wherein diff denotes a difference between a target mask value raised to a power and an estimated mask value of the estimated mask values raised to the power, and m denotes a tuning parameter.

15. The computer-readable, non-transitory storage medium of claim 13,
the loss function being w*diff², and
wherein w=m^{diff}−diff−1, diff denotes a difference between a target mask value raised to a power and an estimated mask value of the estimated mask values raised to the power, and m denotes a tuning parameter.

16. The computer-readable, non-transitory storage medium of claim 13, the method further comprising:
determining whether the audio data corresponds to laughter or applause; and
in response to determining that the audio data corresponds to laughter or applause, further transmitting an alert to ignore the mask.

17. The computer-readable, non-transitory storage medium of claim 13, the method further comprising:
computing derived features of the audio data in a time domain and a frequency domain; and
executing a second digital model for classifying the audio data into laughter or applause or otherwise based on the derived features.

18. The computer-readable, non-transitory storage medium of claim 13, the method further comprising:
computing a mask attenuation for the mask;
determining whether the mask attenuation corresponds to a fall-off amount that exceeds a threshold; and
in response to determining that the mask attenuation corresponds to a fall-off amount that exceeds the threshold, adjusting the mask such that the mask attenuation matches a predetermined voice decay rate.

19. The computer-readable, non-transitory storage medium of claim 13, the method further comprising:
receiving an input waveform in a time domain;
transforming the input waveform into raw audio data over a plurality of frequency bins and the plurality of frames; and
converting the raw audio data into the audio data by grouping the plurality of frequency bins into the plurality of frequency bands.

20. The computer-readable, non-transitory storage medium of claim 19, the method further comprising:
performing inverse banding on the estimated mask values to generate updated mask values for each frequency bin of the plurality of frequency bins and each frame of the plurality of frames;
applying the updated mask values to the raw audio data to generate new output data; and
transforming the new output data into an enhanced waveform.
